(19) United States
(12) Patent Application Publication
(10) Pub. No.: US 2017/0309089 A1
(43) Pub. Date: Oct. 26, 2017

(54) TRAVEL ANALYZING METHOD, TRAVEL ANALYZING APPARATUS, AND COMPUTER-READABLE RECORDING MEDIUM

(71) Applicant: FUJITSU LIMITED, Kawasaki-shi (JP)

(72) Inventors: Takashi SHIMADA, Shinagawa (JP); Kosei Takano, Fujimino (JP); Masayoshi Hoshiya, Yokohama (JP); Masatsugu lsogai, Yokohama (JP)

(73) Assignee: FUJITSU LIMITED, Kawasaki-shi (JP)

(21) Appl. No.: 15/649,205

(22) Filed: Jul. 13, 2017

Related U.S. Application Data
(63) Continuation of application No. PCT/JP2016/050886, filed on Jan. 13, 2016.

(30) Foreign Application Priority Data
Jan. 15, 2015 (JP) 2015-006253

(51) Int. Cl. G07C 5/08; G06F 17/30

(52) U.S. Cl. CPC G07C 5/085; G06F 17/30321

(57) ABSTRACT

A server device receives an input including identification information of a specific driver. The server device specifies, with reference to a storage storing a service period in a specific company and travel data during the service period of the specific driver, the travel data during the service period corresponding to the specific driver. Moreover, the server device acquires a traveling feature during the service period of the specific driver on the basis of the specified travel data so as to output the traveling feature. As a result, it is possible to output the traveling feature of the specific driver.

### CROSS-REFERENCE TO RELATED APPLICATION

This application is a continuation of International Application No. PCT/JP2016/050886, filed on Jan. 13, 2016 which claims the benefit of priority of the prior Japanese Patent Application No. 2015-006253, filed on Jan. 15, 2015, the entire contents of which are incorporated herein by reference.

### FIELD

The embodiment discussed herein is related to a travel analyzing method, a travel analyzing apparatus, and a computer-readable recording medium.

### BACKGROUND

Recently, for example, in the transport industry, information of drivers of vehicles for business use, which is on the numbers of offences against traffic laws and the like, biological information such as breath alcohol content, etc., is managed so as to allot works to drivers while grasping various kinds of information of these drivers, whereby a vehicle accident is to be prevented.
Patent Literature 1: Japanese Laid-open Patent Publication No. 2010-048655

For example, when employing a new driver, in many cases, a company of the transport industry and the like judges the driver from his/her traveling feature by a personal resume, an interview, etc. However, the fact is that the company does not know an actual traveling feature of the driver only from information of the personal resume, the interview, etc.

### SUMMARY

According to an aspect of an embodiment, a travel analyzing method includes receiving an input including identification information of a specific driver. The method includes specifying, with reference to a storage storing a service period in a specific company and travel data during the service period of the specific driver, the travel data during the service period corresponding to the specific driver. The method includes acquiring a traveling feature during the service period of the specific driver based on the specified travel data to output the traveling feature.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of a driver monitoring system according to a present embodiment;

FIG. 2 is a diagram illustrating one example of an operation monitoring device;

FIG. 3 is a diagram illustrating one example of a health measuring device;

FIG. 4 is a diagram illustrating one example of a server device;

FIG. 5 is a diagram illustrating one example of a record configuration of a user database (DB);

FIG. 6 is a diagram illustrating one example of a record configuration of an operation DB;

FIG. 7 is a diagram illustrating one example of a record configuration of an operation history DB;

FIG. 8 is a diagram illustrating one example of traveling information displayed on a display screen of a terminal device;

FIGS. 9 and 10 are flowcharts illustrating one example of process operations of the server device, which is associated with a travel analyzing process;

FIG. 11 is a diagram illustrating one example of a traveling feature displayed on the display screen of the terminal device; and

FIG. 12 is a diagram illustrating one example of a computer that executes a travel analyzing program.

### DESCRIPTION OF EMBODIMENT

Preferred embodiments of the present invention will be explained with reference to accompanying drawings. In addition, the disclosed technology is not limited to the embodiment described below. Moreover, any of the embodiments may be appropriately combined within a consistent range.

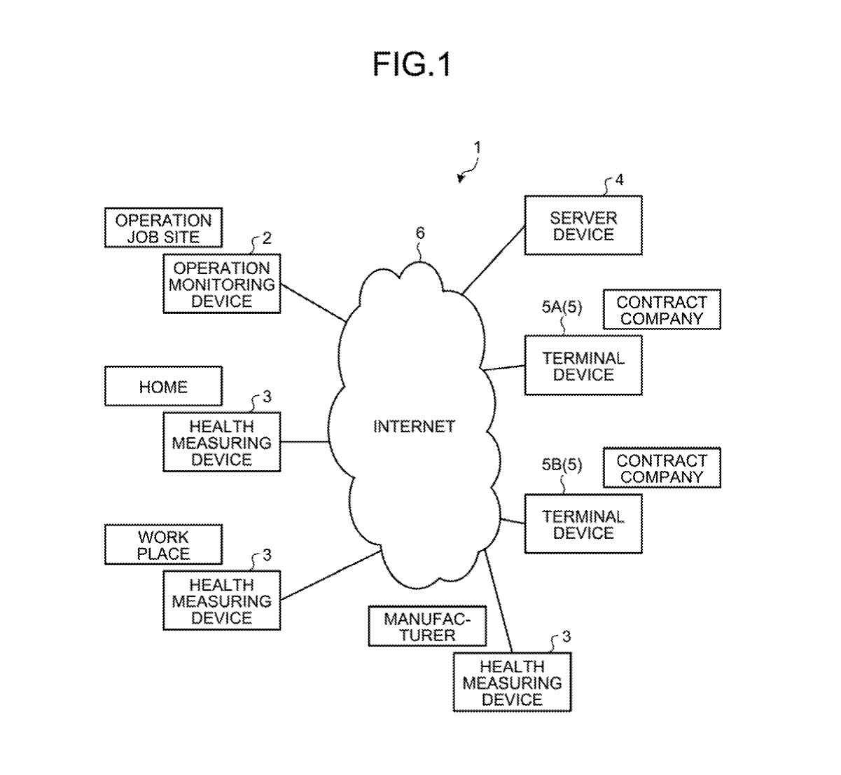

FIG. 1 is a diagram illustrating one example of a driver monitoring system according to a present embodiment. A driver monitoring system 1 illustrated in FIG. 1 includes a plurality of operation monitoring devices 2, a plurality of health measuring devices 3, a server device 4, and a plurality of terminal devices 5. The operation monitoring device 2 is a device that is mounted at a driving seat of a vehicle so as to monitor operation information of a driver of the vehicle, for example. The health measuring device 3 is a device that is provided in a home, a work place, or the like so as to measure biological information of a driver, for example. The health measuring device 3 is a measurement device such as a blood-pressure gauge, a weight scale, a thermometer, an alcohol detector, and a sleep meter. The server device 4 communicably connects the operation monitoring devices 2 with the respective health measuring devices 3 through, for example, an Internet 6. The server device 4 collects, through the Internet 6, pieces of operation information of respective drivers, which are acquired by the operation monitoring devices 2. Moreover, the server device 4 collects, through the Internet 6, pieces of biological information of the respective drivers, which are acquired by the health measuring devices 3. Moreover, the server device 4 generates biological evaluation values and driving evaluation values of the drivers on the basis of these collected pieces of operation and biological information of the drivers, and manages a traveling feature including the biological and driving evaluation values, etc. for each user ID that is for identifying a corresponding driver so as to provide the traveling feature to the terminal device 5.

The terminal device 5 is a terminal device of a company that contracted for the driver monitoring system 1, such as a personal computer provided in a transport company and the like. For example, with respect to the terminal devices 5, the terminal device 5 of a transport company A is referred to as “terminal device 5A” and that of a transport company B is referred to as “terminal device 5B.” The terminal device 5 is communicably connected with the server device 4 through the Internet 6, for example. The terminal device 5 may be communicably connected with, for example, the operation monitoring device 2 through the Internet 6.

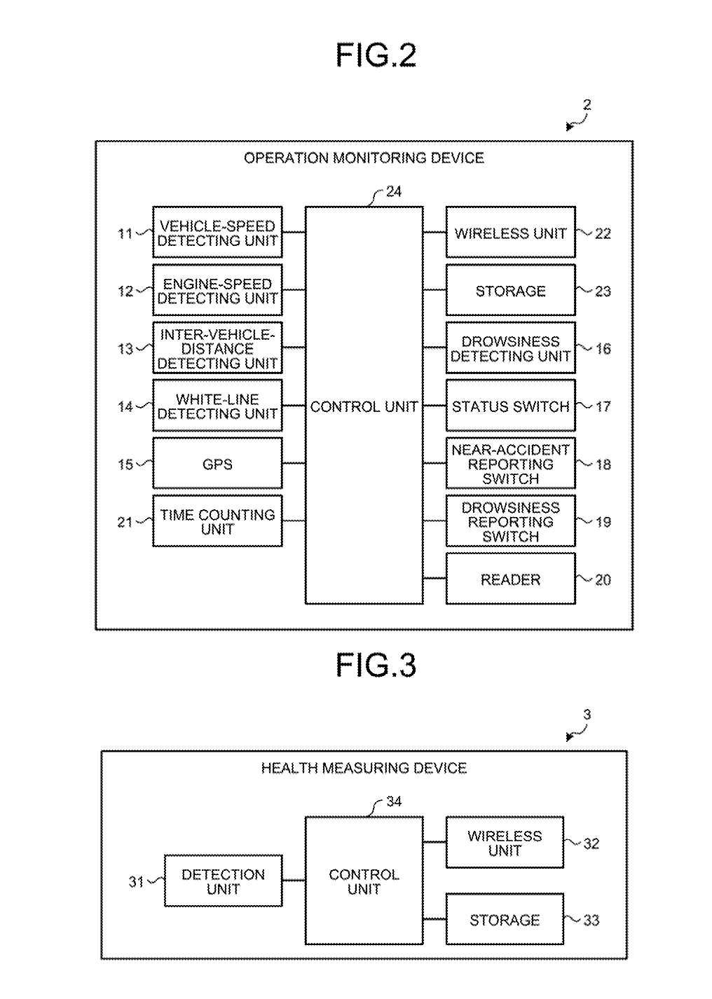

FIG. 2 is a diagram illustrating one example of the operation monitoring device 2. The operation monitoring device 2 illustrated in FIG. 2 includes a vehicle-speed detecting unit 11, an engine-speed detecting unit 12, an inter-vehicle-distance detecting unit 13, a white-line detecting unit 14, a Global Positioning System (GPS) 15, and a drowsiness detecting unit 16. The operation monitoring device 2 includes a status switch 17, a near-accident reporting switch 18, a drowsiness reporting switch 19, a reader 20, a time counting unit 21, a wireless unit 22, a storage 23, and a control unit 24. The vehicle-speed detecting unit 11 is a detection unit that detects a traveling speed and a traveling distance of a vehicle by using, for example, a camera provided in the vehicle. The engine-speed detecting unit 12 is a detection unit that detects an engine speed of a vehicle by using, for example, a sensor provided in the vehicle. The inter-vehicle-distance detecting unit 13 is a detection unit that detects an inter-vehicle distance to a front vehicle by using, for example, a sensor provided in the vehicle. The white-line detecting unit 14 is a detection unit that detects a deviation from a white-line being a road lane by using, for example, a sensor provided in the vehicle. The GPS 15 is a system that measures a present position of a vehicle. The drowsiness detecting unit 16 is a sensor that detects a drowsiness of, for example, a driver of a traveling vehicle.

The status switch 17 is a switch for specifying, for example, a state of a driver of a vehicle. The status switch 17 is a switch for specifying a state such as non-specified, loading, unloading, in a break, and in a sleep. The near-accident reporting switch 18 is a reporting switch that is operated when a driver of a driving vehicle is aware of a near accident, for example. The drowsiness reporting switch 19 is a reporting switch that is operated when a driver of a driving vehicle is aware of his/her drowsiness, for example. The reader 20 performs, for example, non-contact integrated circuit (IC) communication with a driving license, and reads personal information in the driving license so as to identify a user identification (ID) of a driver of a driving vehicle on the basis of the read personal information.

The time counting unit 21 is a clock that counts present date and hour. The wireless unit 22 is, for example, a communication interface that is communicably connected with the Internet 6 in a wireless manner. The storage 23 is a region that stores various kinds of information. The control unit 24 controls a whole of the operation monitoring device 2. The control unit 24 collects, for each driver, detection results of the vehicle-speed detecting unit 11, the engine-speed detecting unit 12, the inter-vehicle-distance detecting unit 13, the white-line detecting unit 14, the drowsiness detecting unit 16, etc. in association with measurement dates and hours so as to store the collected detection results in the storage 23. The control unit 24 collects, for each driver, switch results of the status switch 17, the near-accident reporting switch 18, the drowsiness reporting switch 19, etc. in association with measurement dates and hours so as to store the collected switch result in the storage 23. In other words, the control unit 24 stores, for each driver, operation information on the detection results, the switch results, etc. in the storage 23 in association with the measurement dates and hours.

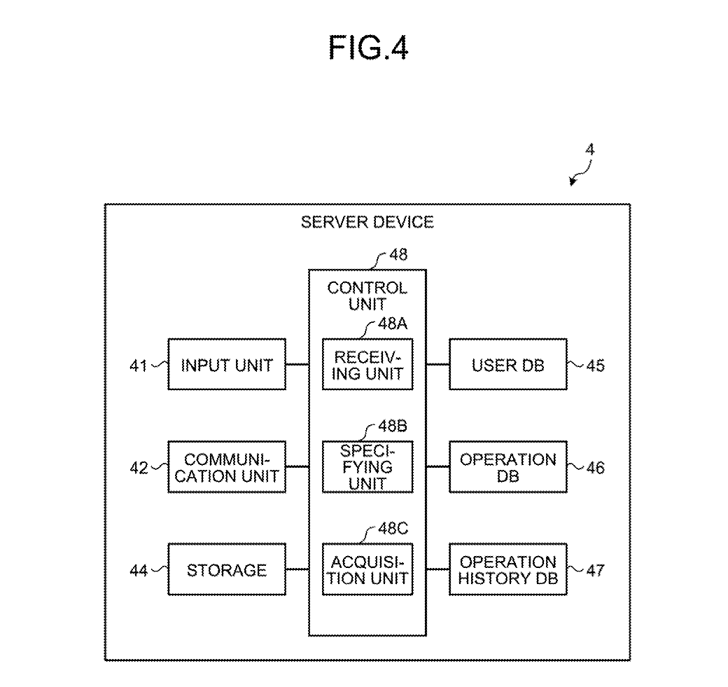

FIG. 3 is a diagram illustrating one example of the health measuring device 3. The health measuring device 3 illustrated in FIG. 3 includes a detection unit 31, a wireless unit 32, a storage 33, and a control unit 34. The detection unit 31 detects biological information of a user. For example, when the health measuring device 3 is a pulse meter, the detection unit 31 is a contact-type or non-contact-type pulse measuring unit that measures a pulse rate of a user. The contact-type unit includes, for example, an earring-type unit that contacts with a body of a user, etc. When the health measuring device 3 is a blood-pressure gauge, the detection unit 31 is, for example, a contact-type or non-contact-type blood pressure measuring unit that measures a blood-pressure value of a user. For example, when the health measuring device 3 is a weight scale, the detection unit 31 is, for example, a contact-type or non-contact type body weight measuring unit that measures a body weight of a user. For example, when the health measuring device 3 is a thermometer, the detection unit 31 is, for example, a contact-type or non-contact-type body-temperature measuring unit that measures a body temperature of a user. For example, when the health measuring device 3 is a measurement device that detects breath alcohol content, the detection unit 31 is a measurement unit that measures breath alcohol content of a user. When the health measuring device 3 is a sleep measuring device, the detection unit 31 is a measurement unit that measures a quality of a sleep of a user.

The wireless unit 32 is a communication interface that is communicably connected with the Internet 6 in a wireless manner, for example. When not having the wireless unit 32 built-in, the health measuring device 3 may have a function for being communicably connected with the Internet 6 by using a terminal device such as a smartphone. The storage 33 is a region that stores, for each user ID that is for identifying a corresponding user of the health measuring device 3, pieces of biological information of measurement dates and hours. The control unit 34 controls a whole of the health measuring device 3. The control unit 34 stores pieces of biological information of measurement dates and hours in the storage 33 for each of the user IDs for identifying a corresponding user of the health measuring device 3.

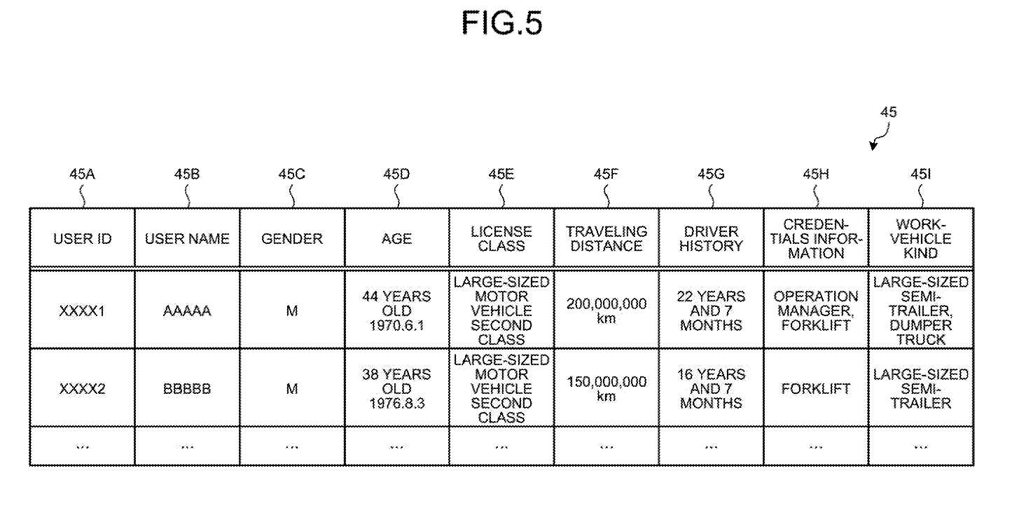

FIG. 4 is a diagram illustrating one example of the server device 4. The server device 4 illustrated in FIG. 4 includes an input unit 41, a communication unit 42, a storage 44, a user database (DB) 45, an operation DB 46, an operation history DB 47, and a control unit 48. The server device 4 collects pieces of biological information of drivers from the health measuring devices 3 through the Internet 6, and further collects pieces of operation information of the drivers from the operation monitoring devices 2 through the Internet 6.

The input unit 41 is an input interface to be used for inputting various commands. The communication unit 42 is, for example, a communication interface that is communicably connected with the Internet 6. The storage 44 is a region for storing various kinds of information of various programs and the like.

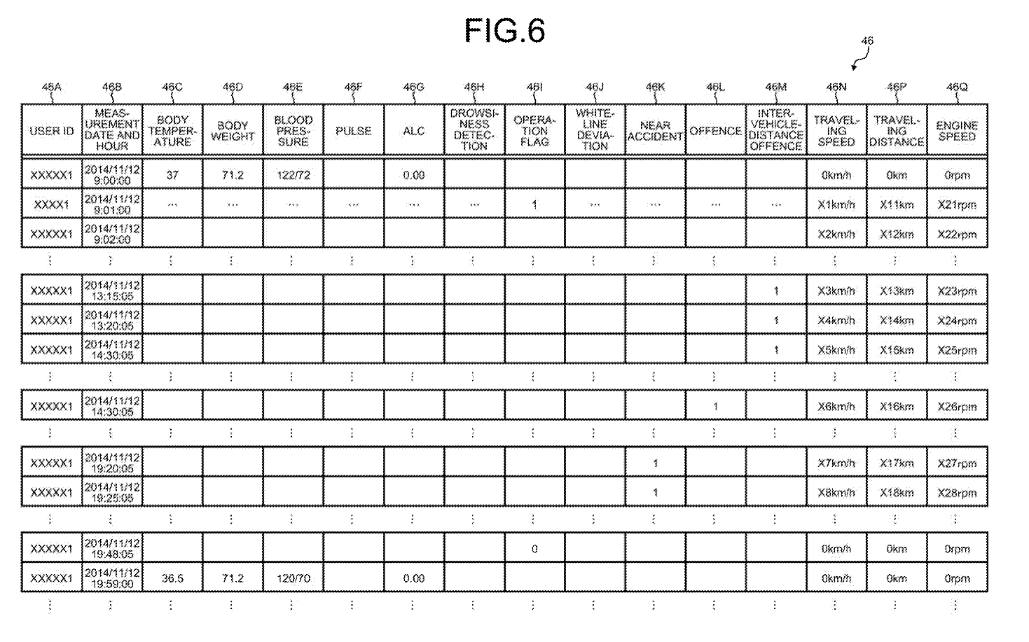

The user DB 45 is a region for storing personal information of a driver for each piece of identification information that is for identifying the corresponding driver. FIG. 5 is a diagram illustrating one example of a record configuration of the user DB 45. The user DB 45 illustrated in FIG. 5 is a region for storing, for each user ID 45A, a user name 45B, a gender 45C, an age 45D, a license class 45E, a traveling distance 45F, a driver history 45G, credentials information 45H, and a work-vehicle kind 451 in association with one another. The user ID 45A is identification information for identifying a driver of a vehicle, for example. The user ID is a common ID by which, for example, a driving license ID of a driver, a company member ID of the driver at a work place, and a user ID of the driver of the health measuring device 3 are tied with one another. The user name 45B is, for example, a full name of a driver. The gender 45C is, for example, a gender of a driver. The age 45D is, for example, age and birth date of a driver. The license class 45E is, for example, a class of a driving license of a driver, such as a large-sized motor vehicle second class. The traveling distance 45F is, for example, a total traveling distance obtained by traveling on vehicles as a driver at work. The driver history 45G is, for example, the total number of years during which a driver experiences works as an occupational driver. The credentials information 45H is, for example, credentials information as an operation manager, a forklift driver, etc. The work-vehicle kind 451 is, for example, vehicle types having experienced in works as a driver of a dumper truck, a large-sized semi-trailer, etc.

For example, the control unit 48 updates and registers, in response to an input operation from the terminal device 5 of a contract company, the user ID 45A, the user name 45B, the gender 45C, the age 45D, the license class 45E, the traveling distance 45F, the driver history 45G, the credentials information 45H, and the work-vehicle kind 451, which are in the user DB 45.

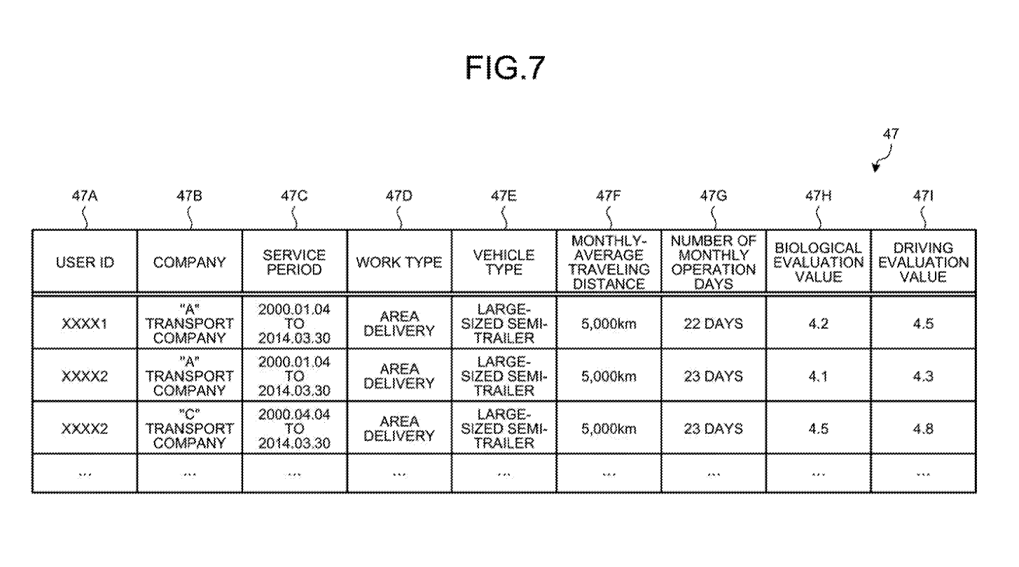

The operation DB 46 is a region for storing biological and operation information of a driver for each user ID 46A that is for identifying the corresponding driver. FIG. 6 is a diagram illustrating one example of a record configuration of the operation DB 46. The operation DB 46 is a region for storing a body temperature 46C, a body weight 46D, a blood pressure 46E, a pulse 46F, and an ALC 46G in association with one another for each of the user IDs 46A and measurement dates and hours 46B. Moreover, the operation DB 46 is a region for storing a drowsiness detection 46H, an operation flag 461, a white-line deviation 46J, a near accident 46K, an offence 46L, and an inter-vehicle-distance offence 46M in association with one another for each of the user IDs 46A and the measurement dates and hours 46B. Moreover, the operation DB 46 is a region for storing a traveling speed 46N, a traveling distance 46P, and an engine speed 46Q in association with one another for each of the user IDs 46A and the measurement dates and hours 46B. The user ID 46A is, for example, an ID for identifying a driver. The measurement date and hour 46B is, for example, measurement date and hour counted by the time counting unit 21. The body temperature 46C is, for example, each of the body temperatures of drivers which are collected by thermometers being the health measuring devices 3. The body weight 46D is, for example, each of the body weights of drivers collected by weight scales being the health measuring devices 3. The blood pressure 46E is, for example, each of blood pressures of drivers collected by blood-pressure gauges being the health measuring device 3. The pulse 46F is, for example, each of pulse rates of drivers collected by pulse meters being the health measuring devices 3. The ALC 46G is, for example, breath alcohol content of a driver detected by an alcohol detector being the health measuring device 3.

The drowsiness detection 46H is, for example, information of “1” indicating an operation of the drowsiness reporting switch 19 in the operation monitoring device 2, in other words, an occurrence of self-awareness in a driver of a drowsiness. The operation flag 461 corresponds to a flag indicating whether or not a driver is in operation, “1” indicating that the driver is in operation is set at the status switch 17 when a start of an operation is specified in the operation monitoring device 2, and “0” indicating that an operation is stopped is set at the status switch 17 when a stop of an operation is specified.

The white-line deviation 46J is, for example, information of “1” indicating an occurrence of a white-line deviation that is detected by the white-line detecting unit 14 in the operation monitoring device 2. The near accident 46K is, for example, information of “1” indicating an operation of the near-accident reporting switch 18 in the operation monitoring device 2, in other words, an occurrence of self-awareness in a driver of a near accident. The offence 46L is, for example, information of “1” indicating an occurrence of an offence, such as a “speed excess” and “sudden acceleration and deceleration,” which is detected from, for example, a detection result of the vehicle-speed detecting unit 11 and the engine-speed detecting unit 12 in the operation monitoring device 2. The inter-vehicle-distance offence 46M is, for example, information of “1” indicating an occurrence of a state where an inter-vehicle distance to a front vehicle is less than a predetermined distance, which is detected by the inter-vehicle-distance detecting unit 13 in the operation monitoring device 2. The traveling speed 46N is, for example, a traveling speed of a traveling vehicle in an operation time zone. The traveling distance 46P is, for example, a traveling distance of a traveling vehicle in an operation time zone. The engine speed 46Q is, for example, an engine speed of a traveling vehicle in an operation time zone.

The control unit 48 registers, in the operation DB 46, measurement results of the health measuring devices 3 along with measurement dates and hours, such as the body temperature 46C, the body weight 46D, the blood pressure 46E, and the ALC 46G. The control unit 48 registers, in the operation DB 46, detection results of the operation monitoring devices 2 along with measurement dates and hours corresponding to detection timings, such as the drowsiness detection 46H, the operation flag 461, the white-line deviation 46J, the near accident 46K, the offence 46L, and the inter-vehicle-distance offence 46M. The control unit 48 collects for each hour, for example, traveling speeds for the corresponding hour, traveling distances for the corresponding hour, and engine speeds for the corresponding hour from the operation monitoring devices 2 so as to register the collected information in the traveling speed 46N, the traveling distance 46P, and the engine speed 46Q of the operation DB 46.

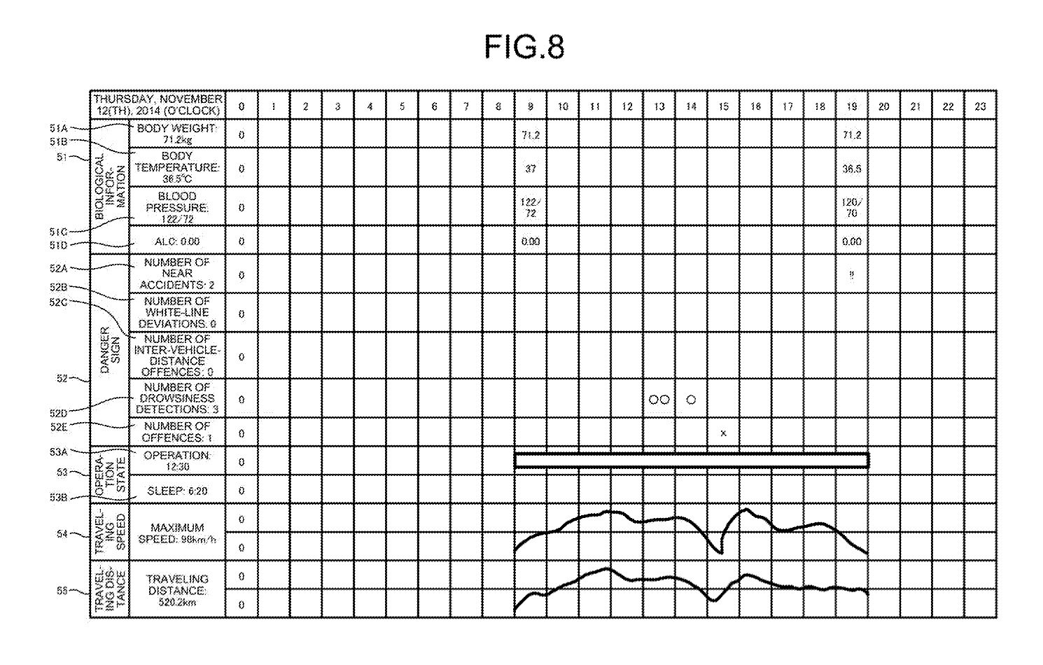

The operation history DB 47 is a region for storing, for each service period in a company of a driver, a biological evaluation value and a driving evaluation value to be mentioned later in association with each other as an operation history of the driver. FIG. 7 is a diagram illustrating one example of a record configuration of the operation history DB 47. The operation history DB 47 illustrated in FIG. 7 is a region for storing, for each user ID 47A, a company 47B, a service period 47C, a work type 47D, a vehicle type 47E, a monthly-average traveling distance 47F, a number of monthly operation days 47G, a biological evaluation value 47H, and a driving evaluation value 47I in association with one another.

The user ID 47A is, for example, an ID for identifying a driver. The company 47B is, for example, a name of a company that is a company of a driver. The service period 47C is, for example, a period during which a driver works for a company. The work type 47D is, for example, a work type such as “area delivery,” in which a driver works as driver for a company. The vehicle type 47E is, for example, a class of a vehicle such as a large-sized semi-trailer, which is used when a driver works as driver for a company. The monthly-average traveling distance 47F is a traveling distance obtained by averaging, in units of months, a traveling distance of a driver at work during a service period in a company. The number of monthly operation days 47G is the number of operation days obtained by averaging, in units of months, operation days in which a driver operates during a service period in a company. The biological evaluation value 47H is an evaluation value of a driver, which is generated by using biological information and operation information associated with a travel of the driver during a service period in a company. The driving evaluation value 47I is an evaluation value of a driver, which is generated by using operation information associated with a travel of the driver during a service period in a company.

The biological evaluation value 47H includes, for example, a continuous driving aptitude, a long-time-interval driving aptitude, a late-night aptitude, and a sleep characteristic. The continuous driving aptitude is, for example, an index having five-stage levels, whose evaluation level is higher as an occurrence extent of no drowsiness and no danger sign is higher in, for example, a continuous travel from a travel start without a break less than thirty minutes. The travel start and the break are determined by detection results of, for example, the status switch 17, the vehicle-speed detecting unit 11, the GPS 15, and the like. The drowsiness is determined by a drowsiness detection of, for example, the drowsiness detecting unit 16, the drowsiness reporting switch 19, or the like. The danger sign is computed by using, for example, the number of near accidents, the number of offences, the number of white-line deviations, and the number of inter-vehicle-distance offences and drowsiness detections. The number of near accidents is, for example, the number of times of switching operations of the near-accident reporting switch 18. The number of offences is the number of times based on, for example, detection results of the vehicle-speed detecting unit 11 and the engine-speed detecting unit 12. The number of white-line deviations is, for example, the number of detection times by the white-line detecting unit 14. The number of inter-vehicle-distance offences is, for example, the number of offence times against an inter-vehicle-distance based on, for example, detection results of the inter-vehicle-distance detecting unit 13. The number of drowsiness detections is the number of, for example, detection results of the drowsiness detecting unit 16 and switching operations of the drowsiness reporting switch 19.

The long-time-interval driving aptitude is an index having, for example, five-stage levels, whose evaluation level is higher as an occurrence extent of no drowsiness and no danger sign is higher even when a rate of an driving-time interval (except for break and rest) to an operation-time interval of a whole of the operation exceeds 60% and the operation-time interval is equal to or more than eight hours. The break, rest, and driving-time interval are determined by, for example, operation results of the status switches 17, etc.

The late-night aptitude is an index having, for example, five-stage levels, whose evaluation level is higher as an occurrence extent of no drowsiness and no danger sign is higher in a late-night time zone, for example, from 22:00 to 4:00. The sleep characteristic is an index having, for example, five-stage levels, whose evaluation level is higher as: (i) a shift to a deep sleep is faster; (ii) quality of sleep is higher; or (iii) an occurrence extent of no drowsiness and no danger sign is higher even in a case of an operation with divided rests. The quality of sleep is measured by, for example, a sleep measuring device.

The driving evaluation value 47I includes, for example, a start/stop adequacy degree, a constant-speed-travel adequacy degree, a maximum-speed adequacy degree, an engine-brake utilization degree, and an idling state adequacy degree. The start/stop adequacy degree is an index having, for example, five-stage levels, whose evaluation level is higher as a frequency of being equal to or less than “yy” km/h per second of, for example, an acceleration from a stop state or a stop from a traveling state is higher, in other words, an extent of a calm start and stop is higher. The start and stop states are acquired from detection results of, for example, the vehicle-speed detecting unit 11, the engine-speed detecting unit 12, the GPS 15, etc.

The constant-speed-travel adequacy degree is an index having, for example, five-stage levels, whose evaluation level is higher as a frequency of being equal to or less than “xx” km/h per second of, for example, a change in traveling speed is higher. The change in speed is acquired from detection results of, for example, the vehicle-speed detecting unit 11, the time counting unit 21, the GPS 15, etc. The maximum-speed adequacy degree is an index having, for example, five-stage levels, whose evaluation level is higher as a frequency of being equal to or less than 90 km/h of, for example, a maximum speed of traveling speeds acquired in, for example, one operation. The one operation is acquired from, for example, an operation start and an operation stop, which are operation results of the status switch 17, and a measurement time of the time counting unit 21. The maximum speed is acquired from traveling speeds that are detection results of the vehicle-speed detecting unit 11.

The engine-brake utilization degree is an index having, for example, five-stage levels, whose evaluation level is higher as a use frequency of an engine brake in deceleration is higher. The use frequency of the engine brake is acquired from traveling speeds and engine speeds that are detection results of, for example, the vehicle-speed detecting unit 11 and the engine-speed detecting unit 12. The idling-state adequacy degree is an index having, for example, five-stage levels, whose evaluation level is higher as a frequency of an idling state, where, for example, an engine speed in a stop state is equal to or more than “xxx” rpm and continues for equal to or more than “yyy” minutes, is higher. The idling state is acquired from traveling speeds and engine speeds that are detection results of, for example, the vehicle-speed detecting unit 11 and the engine-speed detecting unit 12.

The control unit 48 updates and registers, for example, in response to an input operation from the terminal device 5 of the contract company, the user ID 47A, the company 47B, the service period 47C, the work type 47D, and the vehicle type 47E, which are in the operation history DB 47. Moreover, the control unit 48 computes the monthly-average traveling distance 47F and the number of monthly operation days 47G on the basis of the service period 47C and the traveling distance 46P and the operation flag 461 in the operation DB 46 and updates and registers, in the operation history DB 47, the monthly-average traveling distance 47F and the number of monthly operation days 47G.

The control unit 48 generates, on the basis of operation and biological information during a service period in a company corresponding to the user ID 46A in the operation DB 46, biological and driving evaluation values during the service period in the company corresponding to the user ID. Moreover, the control unit 48 registers the generated biological evaluation value 47H and the generated driving evaluation value 47I in the operation history DB 47.

The control unit 48 ties data in, for example, the user DB 45, the operation DB 46, and the operation history DB 47 with one another by using the user ID 45A (46A, 47A).

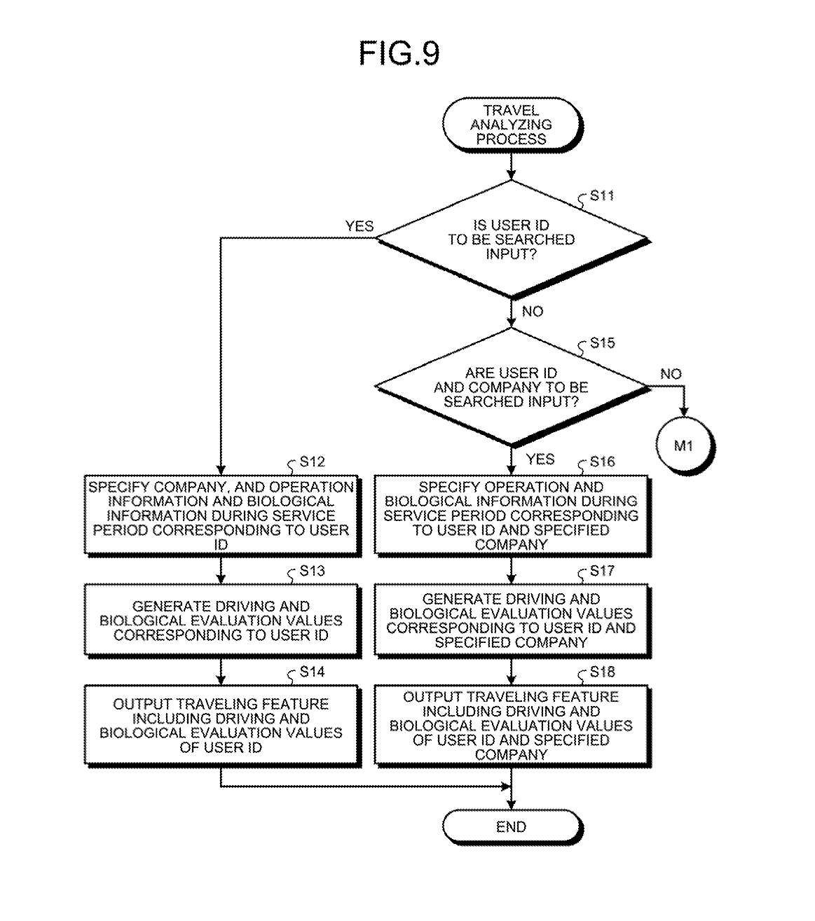

The control unit 48 acquires, from the terminal device 5 through the Internet 6, biological and operation information in the operation DB 46 in response to a display request that requests to display, for example, a user ID of a specific driver and traveling information of a specific date. The control unit 48 provides, to the terminal device 5 of the display requesting source, the acquired biological and operation information as traveling information. FIG. 8 is a diagram illustrating one example of traveling information displayed on a display screen of the terminal device 5. The display screen illustrated in FIG. 8 displays, by using a screen, one-day traveling information of Nov. 12, 2014 associated with a specific driver. Traveling information causes biological information 51, a danger sign 52, an operation state 53, a traveling speed 54, and a traveling distance 55 to be displayed. In display items of the biological information 51, for example, a body weight 51A, a body temperature 51B, a blood pressure 51C, and an ALC 51D are displayed. The control unit 48 searches the body temperature 46C, the body weight 46D, the blood pressure 46E, and the ALC 46G with reference to the measurement date and hour 46B corresponding to specific user ID and date in the operation DB 46, so as to use the search result as the biological information 51.

In display items of the danger sign 52, a near accident 52A, a white-line deviation 52B, an inter-vehicle-distance offence 52C, a drowsiness detection 52D, and an offence 52E are displayed. The control unit 48 searches the drowsiness detection 46H, the white-line deviation 46J, the near accident 46K, the offence 46L, and the inter-vehicle-distance offence 46M with reference to the measurement date and hour 46B corresponding to specific user ID and date in the operation DB 46, so as to use the search result as the danger sign 52. In display items of the danger sign 52, presences/absences of occurrences of the near accident 52A, the white-line deviation 52B, the inter-vehicle-distance offence 52C, the drowsiness detection 52D, and the offence 52E are displayed in units of hours, and further the total numbers of occurrence times on the specified date are displayed.

In display items of the operation state 53, an operation-time interval of a driver vehicle is displayed in a bar-graph form, and further an operation-time interval 53A and a sleep-time interval 53B are displayed. The control unit 48 searches the operation flag 461 corresponding to a specific user ID and date and hour in the operation DB 46, so as to use the search result as the operation state 53.

In display items of the traveling speed 54, a traveling speed of a driver vehicle for specified days is displayed in a graph form, and further a maximum speed of the specified days is displayed. The control unit 48 searches the traveling speed 46N with reference to the measurement date and hour 46B corresponding to a specified user ID and date in the operation DB 46, so as to use the search result as the traveling speed 54.

In display items of the traveling distance 55, a traveling distance of a driver vehicle for specified days is displayed in a graph form, and further a total traveling distance of the specified days is displayed. The control unit 48 searches the traveling distance 46P with reference to the measurement date and hour 46B corresponding to a specified user ID and date in the operation DB 46, so as to use the search result as the traveling distance 55.

In other words, the control unit 48 provides to the terminal device 5 of the display requesting source, in response to a request from the terminal device 5 for displaying traveling information of specified driver and date, traveling information on the biological information 51, the danger sign 52, the operation state 53, the traveling speed 54, the traveling distance 55, etc. of the specified driver and date. As a result, a user of the terminal device 5 of the display request can visually recognize the traveling information illustrated in FIG. 8, and can specify a driver and a date and hour, so that it is possible to recognize, in units of hours, traveling information of the specified driver and date.

The control unit 48 reads a travel analyzing program stored in the storage 44, and executes the read travel analyzing program as functions of the travel analyzing process. The control unit 48 includes, as a function configuration, a receiving unit 48A, a specifying unit 48B, and an acquisition unit 48C. The receiving unit 48A receives, from the terminal device 5 of the contract company, a request for searching a traveling feature of a specific driver through, for example, the Internet 6. The specifying unit 48B specifies from the operation DB 46, with reference to the measurement date and hour 46B according to the user ID 46A of the driver in the operation DB 46 to be searched, operation and biological information during a service period in a company. The specifying unit 48B specifies, as operation information corresponding to a specified user ID, a company, and a service period, the operation flag 461, the traveling speed 46N, the number of the drowsiness detections 46H, the number of the white-line deviations 46J, the number of the near accidents 46K, the number of the offences 46L, and the number of the inter-vehicle-distance offences 46M.

The acquisition unit 48C computes, on the basis of information specified by the specifying unit 48B, a continuous driving aptitude, a long-time-interval driving aptitude, a late-night aptitude, and a sleep characteristic in a biological evaluation value. The acquisition unit 48C adjusts the biological evaluation value in consideration of the number of abnormality determining times in each of which a body temperature, a blood pressure, a pulse, or an ALC in biological information exceeds a reference value.

The acquisition unit 48C computes a start/stop adequacy degree in a driving evaluation value on the basis of a specified user ID, the traveling speed 46N, the traveling distance 46P, the engine speed 46Q, and a first reference speed (“yy” km/h), which are corresponding to a company and a service period in the operation DB 46.

The acquisition unit 48C computes a constant-speed-travel adequacy degree in a driving evaluation value on the basis of the traveling speed 46N, the traveling distance 46P, and a second reference speed (“xx” km/h) in the operation DB 46, which are corresponding to a specified user ID, a company, and a service period. The acquisition unit 48C computes a maximum-speed adequacy degree in a driving evaluation value on the basis of the traveling speed 46N and a third reference value (“90” km/h) in the operation DB 46, which are corresponding to a specified user ID, a company, and a service period.

The acquisition unit 48C computes an engine-brake utilization degree in a driving evaluation value on the basis of an operation-time interval based on the operation flag 461, the traveling speed 46N, the traveling distance 46P, and the engine speed 46Q in the operation DB 46, which are corresponding to a specified user ID, a company, and a service period. The acquisition unit 48C computes an idling-state adequacy degree in a driving evaluation value on the basis of an operation-time interval based on the operation flag 461, the traveling speed 46N, the traveling distance 46P, the engine speed 46Q, and a reference engine speed (“xxx” rpm), which are corresponding to a specified user ID, a company, and a service period.

The acquisition unit 48C generates a biological evaluation value of a company and a service period corresponding to a specified user ID by using the computed continuous driving aptitude, the computed long-time-interval driving aptitude, the computed late-night aptitude, and the computed sleep characteristic. Moreover, the acquisition unit 48C generates a driving evaluation value of a company and a service period corresponding to a specified user ID on the basis of the computed start/stop adequacy degree, the computed constant-speed-travel adequacy degree, the computed maximum-speed adequacy degree, the computed engine-brake utilization degree, and the computed idling-state adequacy degree. The acquisition unit 48C provides, to the terminal device 5 of the search requesting source, a traveling feature including the driving evaluation value, the biological evaluation value, the service history, etc. of the service period in the company corresponding to the user ID, in addition to personal information corresponding to the user ID to be searched.

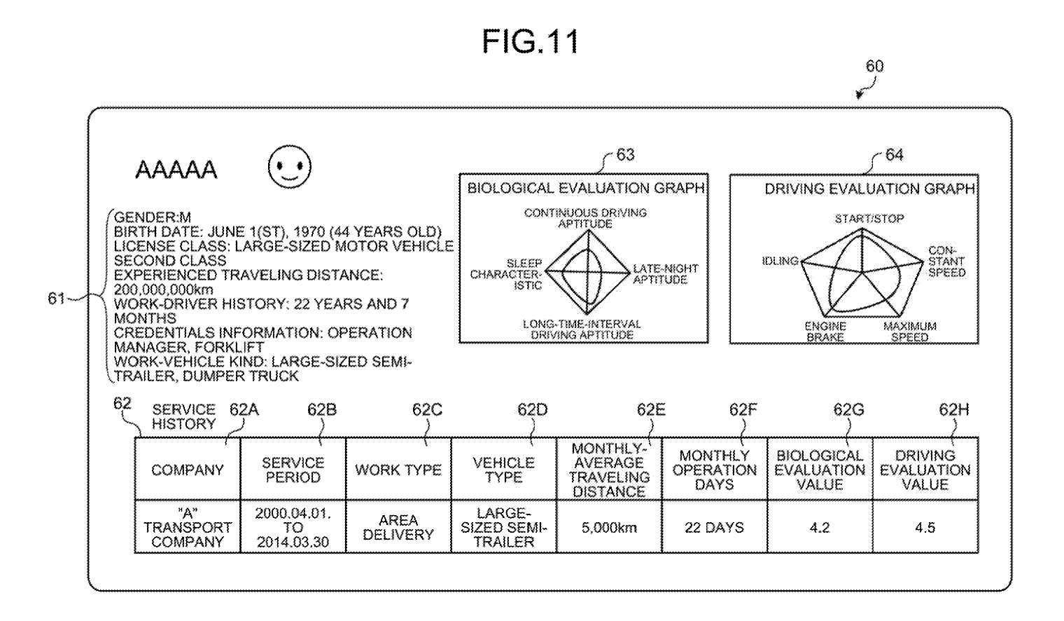

FIG. 11 is a diagram illustrating one example of a traveling feature displayed on the display screen of the terminal device 5. The display screen illustrated in FIG. 11 displays a traveling feature 60 including personal information 61 of a user ID to be searched; and a company of the user ID and a service history 62 in a service period; and the like. The traveling feature 60 includes the personal information 61, the service history 62, a biological evaluation graph 63, and a driving evaluation graph 64. The personal information 61 is a search result of the user name 45B, the gender 45C, the age 45D, the license class 45E, the traveling distance 45F, the driver history 45G, the credentials information 45H, the work-vehicle kind 451, etc., which corresponds to the user ID 45A to be searched in the user DB 45. The service history 62 is a search result including the company 47B, the service period 47C, the work type 47D, the vehicle type 47E, the monthly-average traveling distance 47F, the number of monthly operation days 47G, the biological evaluation value 47H, the driving evaluation value 47I, etc., which corresponds to the user ID 47A to be searched in the operation history DB 47. In other words, the service history 62 includes a company 62A, a service period 62B, a work type 62C, a vehicle type 62D, a monthly-average traveling distance 62E, a number of monthly operation days 62F, a biological evaluation value 62G, and a driving evaluation value 62H of a user ID to be searched. The biological evaluation graph 63 is obtained by graphing, for example, the continuous driving aptitude, the long-time-interval driving aptitude, the late-night aptitude, and the sleep characteristic in the biological evaluation value. The driving evaluation graph 64 is obtained by graphing, for example, the start/stop adequacy degree, the constant-speed-travel adequacy degree, the maximum-speed adequacy degree, the engine-brake utilization degree, and an idling-state adequacy degree in the driving evaluation value.

As illustrated in FIG. 11, a user of the terminal device of the search requesting source visually recognizes a traveling feature of a specific driver on a display screen. As a result, a user can recognize a traveling feature based on actual results of a specific driver, such as a continuous driving aptitude, a long-time-interval driving aptitude, a late-night aptitude, a sleep characteristic, a start/stop adequacy degree, a constant-speed-travel adequacy degree, a maximum-speed adequacy degree, an engine-brake utilization degree, and an idling-state adequacy degree.

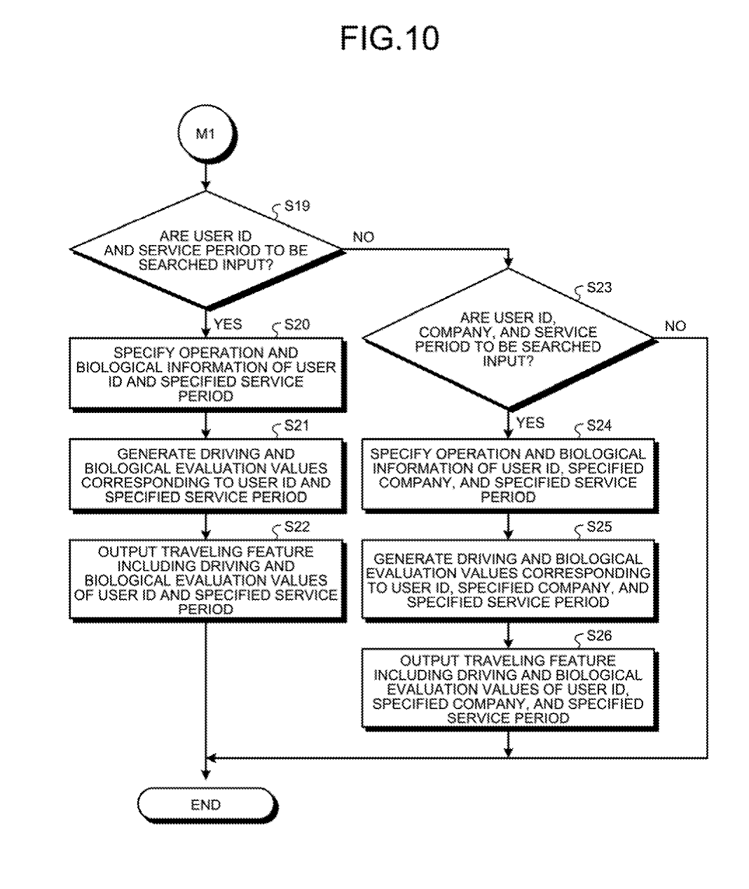

Next, operations of the driver monitoring system 1 according to the present embodiment will be explained. FIGS. 9 and 10 are flowcharts illustrating one example of process operations of the server device 4, which is associated with a travel analyzing process. The travel analyzing process illustrated in FIG. 9 is a process for generating driving and biological evaluation values during a service period in a company of a specific driver on the basis of operation and biological information corresponding to the specific driver so as to output a traveling feature including the generated driving and biological evaluation values.

As illustrated in FIG. 9, the receiving unit 48A in the control unit 48 of the server device 4 determines whether or not a search target of an input is only a user ID specified from the terminal device 5 (Step S11). When a search target of an input is only a user ID (Step S11: Yes), the specifying unit 48B of the control unit 48 specifies, from the operation DB 46, a company, and operation and biological information during a service period corresponding to the user ID (Step S12). The operation information includes, for example, the drowsiness detection 46H, the operation flag 461, the white-line deviation 46J, the near accident 46K, the offence 46L, the inter-vehicle-distance offence 46M, the traveling speed 46N, the traveling distance 46P, the engine speed 46Q, etc. in the operation DB 46. The biological information includes, for example, the body temperature 46C, the body weight 46D, the blood pressure 46E, the pulse 46F, the ALC 46G, etc. in the operation DB 46.

The acquisition unit 48C of the control unit 48 generates driving and biological evaluation values during the service period in the company corresponding to the specified user ID on the basis of the specified company and operation and biological information during the specified service period (Step S13). The acquisition unit 48C stores, in the operation history DB 47, the driving and biological evaluation values corresponding to the user ID. Moreover, the acquisition unit 48C outputs, to the terminal device 5 of the search requesting source, a traveling feature including the personal information, the driving and biological evaluation values, etc. corresponding to the user ID (Step S14), and terminates the process operations illustrated in FIG. 9. The terminal device 5 of the search requesting source displays on a display screen the traveling feature obtained by totalizing all of the companies and all of the service periods of the specific driver. As a result, a user of the terminal device 5 of the search requesting source can specify the user ID to be able to visually recognize the traveling feature of the specific driver with respect to all of the companies and the traveling feature during all of the service periods.

When a search target of an input is not only a user ID (Step S11: No), the receiving unit 48A determines whether or not the search target of the input is a user ID and a company specified from the terminal device 5 (Step S15). When a search target of an input is the specified user ID and company (Step S15: Yes), the specifying unit 48B specifies, from the operation DB 46, operation and biological information during a service period corresponding to the specified user ID and company (Step S16).

The acquisition unit 48C generates driving and biological evaluation values corresponding to the specified user ID and company on the basis of the operation and biological information during the specified service period (Step S17). The acquisition unit 48C stores, in the operation history DB 47, the driving and biological evaluation values corresponding to the specified user ID and company. Moreover, the acquisition unit 48C outputs, to the terminal device 5 of the search requesting source, the personal information and a traveling feature, which include the driving and biological evaluation values etc., corresponding to the specified user ID and company (Step S18), and terminates the process operations illustrated in FIG. 9. The terminal device 5 of the search requesting source displays, on a display screen, the traveling feature of the specific driver during the service period in the specified company. As a result, a user of the terminal device 5 of the search requesting source can specify a company to be able to visually recognize traveling feature of a specific driver during a service period in the specified company.

When a search target of an input is not the specified user ID and company (Step S15: No), the receiving unit 48A shifts the process to M1 illustrated in FIG. 10. In M1 illustrated in FIG. 10, the receiving unit 48A determines whether or not a search target of an input is a user ID and a service period specified from the terminal device 5 (Step S19). When a search target of an input is the specified user ID and service period (Step S19: Yes), the specifying unit 48B specifies, from the operation DB 46, operation and biological information during a service period corresponding to the specified user ID and service period (Step S20).

The acquisition unit 48C generates driving and biological evaluation values corresponding to the user ID and the service period on the basis of the operation and biological information during the specified service period (Step S21). The acquisition unit 48C stores, in the operation history DB 47, the driving and biological evaluation values corresponding to the specified user ID and service period. Moreover, the acquisition unit 48C outputs, to the terminal device 5 of the search requesting source, a traveling feature including the personal information, the driving and biological evaluation values, etc. corresponding to the specified user ID and service period (Step S22), and the process operations illustrated in FIG. 10 is terminated. The terminal device 5 of the search requesting source displays, on a display screen, the traveling feature of the specific driver during the specified service period. As a result, a user of the terminal device 5 of the search requesting source can specify the service period to be able to visually recognize a traveling feature of a specific driver during the specified service period.

When a search target of an input is not the specified user ID and service period (Step S19: No), the receiving unit 48A determines whether or not the search target of the input is a user ID, a company, and a service period specified from the terminal device 5 (Step S23). When a search target of an input is the specified user ID, company, and service period (Step S23: Yes), the specifying unit 48B specifies, from the operation DB 46, operation and biological information corresponding to the specified user ID, company, and service period (Step S24).

The acquisition unit 48C generates driving and biological evaluation values corresponding to the user ID, the company, and the service period on the basis of the operation and biological information during the specified service period (Step S25). The acquisition unit 48C stores, in the operation history DB 47, the driving and biological evaluation values corresponding to the specified user ID, company, and service period. The acquisition unit 48C outputs, to the terminal device 5 of the search requesting source, a traveling feature including the personal information, driving and biological evaluation values, etc. corresponding to the user ID, the company, and the service period specified from the terminal device 5 of the search requesting source (Step S26), and the process operations illustrated in FIG. 10 is terminated. The terminal device 5 of the search requesting source displays, on a display screen, the specified company of the specific driver and the traveling feature during the specified service period. As a result, a user of the terminal device 5 of the search requesting source can specify the company and the service period to be able to visually recognize the specified company of the specific driver and the traveling feature during the specified service period.

When a search target of an input is not the specified user ID, company, and service period (Step S23: No), the receiving unit 48A terminates the process operations illustrated in FIG. 10.

When detecting a search-request input of a user ID from the terminal device 5, the control unit 48 that is to execute a travel analyzing process specifies operation information and biological information of a company during a service period corresponding to a user ID, and generates a driving evaluation value and a biological evaluation value on the basis of the specified operation and biological information. Moreover, the control unit 48 provides, to the terminal device 5 of the a search requesting source, a traveling feature including personal information, a driving evaluation value and a biological evaluation value, etc. of the user ID. As a result, a user of the terminal device 5 of the search requesting source can specify a user ID to be able to recognize a traveling feature obtained by totalizing all of the companies and all of the service periods of the specific driver.

When detecting a search-request input of a user ID and a company from the terminal device 5, the control unit 48 specifies operation information and biological information during a service period corresponding to the user ID and the company so as to generate a driving evaluation value and a biological evaluation value on the basis of the specified operation and biological information. Moreover, the control unit 48 provides, to the terminal device 5 of the search requesting source, a traveling feature including the personal information, the driving and biological evaluation values, etc. of the user ID. As a result, a user of the terminal device 5 of the search requesting source can specify a company to be able to recognize the traveling feature during the service period in the specified company of the specific driver.

When detecting a search-request input of a user ID and a service period from the terminal device 5, the control unit 48 specifies operation information and biological information corresponding to the user ID and the service period so as to generate a driving evaluation value and a biological evaluation value on the basis of the specified operation and biological information. Moreover, the control unit 48 provides, to the terminal device 5 of the search requesting source, a traveling feature including the personal information, the driving and biological evaluation values, etc. of the user ID. As a result, a user of the terminal device 5 of the search requesting source can specify a service period to be able to recognize a traveling feature during the specified service period of the specific driver.

When detecting a search-request input of a user ID, a company, and a service period from the terminal device 5, the control unit 48 specifies operation information and biological information corresponding to the user ID, the company, and the service period so as to generate a driving evaluation value and a biological evaluation value on the basis of the specified operation and biological information. Moreover, the control unit 48 provides, to the terminal device 5 of the search requesting source, a traveling feature including the personal information, the driving and biological evaluation values, etc. of the user ID. As a result, a user of the terminal device 5 of the search requesting source can specify a company and a service period to be able to recognize a traveling feature during the specified service period in the specified company of the specific driver.

The server device 4 according to the present embodiment receives an input including a user ID of a specific driver from the terminal device 5, and specifies operation information and biological information during a service period in a company from the operation DB 46 with reference to measurement date and hour corresponding to the user ID. The server device 4 generates a driving evaluation value and a biological evaluation value during the service period of the company of the specific driver on the basis of the specified operation and biological information, and provides a traveling feature including these driving and biological evaluation values, etc. to the terminal device 5 of the search requesting source. As a result, a user of the terminal device 5 of the search requesting source can specify a driver to be able to recognize a traveling feature during a service period of a company of the specific driver. The user can recognize the traveling feature based on actual results of the specific driver, and thus, for example, can be used in not only employment selection but also work distribution.

The server device 4 receives, from the terminal device 5, an input including a user ID and a service period of a specific driver, and specifies, from the operation DB 46, operation information and biological information during the specified service period with reference to measurement date and hour corresponding to the user ID. The server device 4 generates a driving evaluation value and a biological evaluation value during the specified service period of the specific driver on the basis of the specified operation and biological information, and provides, to the terminal device 5 of the search requesting source, a traveling feature including these driving and biological evaluation values, etc. As a result, a user of the terminal device 5 of the search requesting source can specify a driver and a service period to be able to recognize a traveling feature during the specified service period of the specific driver. The user can recognize the traveling feature based on actual results of the specific driver, and thus, for example, can be used in not only employment selection but also work distribution.

The server device 4 provides, to the terminal device 5 of the search requesting source, a traveling feature including the biological and driving evaluation values, etc. during service period in the company of the specific driver. As a result, a user can easily extract a driver having actual results of safe driving.

In the above embodiment, for example, a body temperature, a body weight, a blood pressure, a pulse, and an ALC are exemplified as biological information and, for example, a sleep detection, a white-line deviation, a near accident, an offence, an inter-vehicle-distance offence, a traveling speed, a traveling distance, an engine speed, etc. are exemplified as operation information. However, not limited thereto, may be appropriately changed.

In the above embodiment, when there exists a search-request input of a user ID, the server device 4 specifies biological and operation information during a service period in a company corresponding to the user ID from the operation DB 46 so as to generate driving and biological evaluation values on the basis of the specified biological and operation information. However, the server device 4 may specify biological and operation information during a service period of a company corresponding to a user ID and may provide the specified biological and operation information to the terminal device 5 of the search requesting source. Driving and biological evaluation values may be generated on the basis of the biological and operation information specified by the terminal device 5 of the search requesting source. In this case, processing load on the server device 4-side can be reduced.

In the above embodiment, for example, a continuous driving aptitude, a long-time-interval driving aptitude, a late-night aptitude, a sleep characteristic, etc. are exemplified as a biological evaluation value, not limited thereto, may be appropriately changed in a case of an index by which the driving can be objectively evaluated from a viewpoint of biological information.

In the above embodiment, for example, a start/stop adequacy degree, a constant-speed-travel adequacy degree, a maximum-speed adequacy degree, an engine-brake utilization degree, an idling-state adequacy degree, etc. are exemplified as a driving evaluation value. However, not limited thereto, may be appropriately changed in a case of index by which the driving can be objectively evaluated from a viewpoint of operation information.

In the above embodiment, the operation monitoring device 2 and the health measuring device 3 are explained to be separated, the operation monitoring device 2 may have functions of the health measuring device 3.

In the above embodiment, a user ID is specified from the terminal device 5 of the search requesting source, and driving and biological evaluation values during a service period of a company corresponding to the specified user ID are generated. However, for example, a work type, a company, or a service period may be specified to generate driving and biological evaluation values corresponding to a user ID according to the specified item.

In the above embodiment, an operation start and an operation stop are determined in accordance with operation flags corresponding to switching operations of the status switch 17, the operation start and the operation stop may be determined in accordance with presence/absence of a vehicle travel detected by the vehicle-speed detecting unit 11.

The operation monitoring device 2 informs the server device 4 of a traveling speed, a traveling distance, and an engine speed of a vehicle in units of hours, not limited to units of hours, the intervals can be appropriately changed.

When generating driving or biological evaluation values, the server device 4 may weight the evaluation values in accordance with an index of biological or operation information, such as a length of a driver history. The user DB 45, the operation DB 46, and the operation history DB 47 in the server device 4 are explained to be separated, however, the user DB 45, the operation DB 46, and the operation history DB 47 may be the same DB.

The server device 4 provides, to the terminal device 5, a traveling feature including driving and biological evaluation values etc., for example, may provide, to the terminal device 5, only one part of aptitudes in the driving evaluation value, such as a late-night aptitude and a long-time-interval driving aptitude, may be a traveling feature.

In the driver monitoring system 1 according to the above embodiment, the operation monitoring device 2, the server device 4, the terminal device 5, etc. are communicably connected with one another through the Internet 6. However, instead of the Internet 6, for example, a Local Area Network (LAN) etc. may be used, and the Internet 6 can be appropriately changed.

In the above embodiment, the server device 4 is a computer, and the terminal device 5 is a computer of a contract company, however, various functions and various kinds of information of the server device 4 and the terminal device 5 may be realized by the cloud computing.

In addition, each component of each apparatus illustrated in the drawings is functionally conceptual, and thus, does not always physically configured as illustrated in the drawings. Namely, a specific mode of separation or integration of each apparatus is not limited to that illustrated in the drawings. That is, all or some of the components can be configured by separating or integrating them functionally or physically in any unit, according to various types of loads, the status of use, etc.

Moreover, all or arbitrary part of the various processing functions, which are to be executed by a computer constituting each of the server device 4 and the terminal device 5, may be executed by a Central Processing Unit (CPU) or a microcomputer such as a Micro Processing Unit (MPU) and a Micro Controller Unit (MCU). Furthermore, it is needless to say that all or arbitrary part of the various processing functions may be executed by a program that is analyzed and executed by a CPU or a microcomputer such as an MPU and an MCU, or hardware by a wired logic.

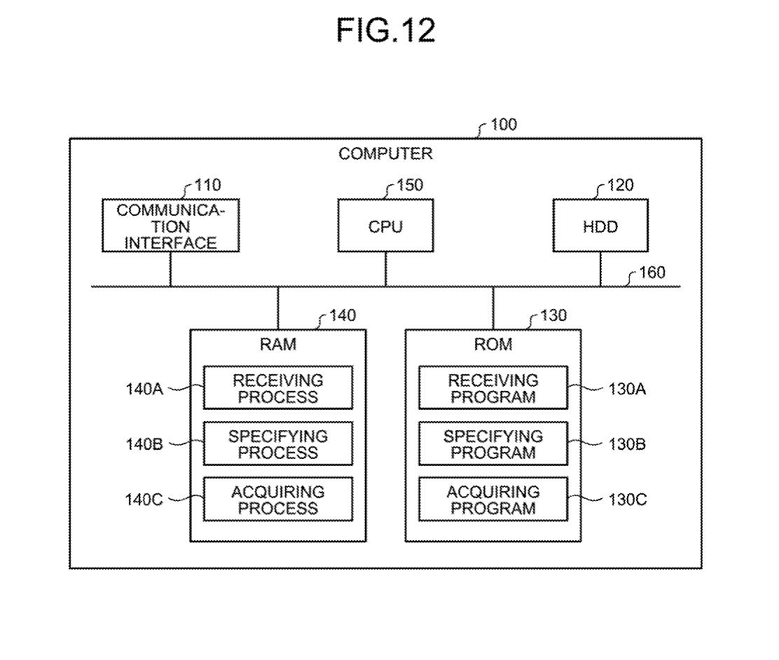

Meanwhile, already-explained various processes according to the present embodiment can be realized by a computer executing previously prepared programs. Hereinafter, one example of a computer will be explained, which executes programs having similar functions to those according to the above embodiment. FIG. 12 is a diagram illustrating one example of a computer 100 that executes a travel analyzing program.

The computer 100 illustrated in FIG. 12, which executes a travel analyzing program, includes a communication interface 110, a Hard Disk Drive (HDD) 120, a Read Only Memory (ROM) 130, a Random Access Memory (RAM) 140, a CPU 150, and a bus 160.

The ROM 130 previously stores a travel analyzing program that exerts functions similar to those according to the above embodiment. The processing program may be stored in, not the ROM 130, a recording medium that can be read by a drive device (not illustrated). The recording medium may be a portable recording medium such as a Compact Disc-Read Only Memory (CD-ROM), a Digital Versatile Disc (DVD), a Universal Serial Bus memory (USB memory), and a Secure Digital card (SD card); a HDD; or a semiconductor memory such as a flash memory. The processing programs include a receiving program 130A, a specifying program 130B, and an acquiring program 130C. The receiving program 130A, the specifying program 130B, and the acquiring program 130C may be appropriately integrated or separated.

The CPU 150 reads any of the receiving program 130A, the specifying program 130B, and the acquiring program 130C from the ROM 130 so as to execute the corresponding read program. The CPU 150 causes programs 130A, 130B, and 130C to function, in the RAM 140, as a receiving process 140A, a specifying process 140B, and an acquiring process 140C, respectively. The HDD 120 includes a storage that stores a service period in a specific company of a specific driver and a travel data during this service period.

The CPU 150 receives an input including identification information of a specific driver. The CPU 150 specifies travel data during a service period corresponding to the specific driver with reference to a storage. Moreover, the CPU 150 acquires a traveling feature during the service period of the specific driver on the basis of the specified travel data, and outputs the traveling feature. As a result, the traveling feature of the specific driver can be output.

According to an aspect of an embodiment, it is possible to output a traveling feature of a specific driver.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A travel analyzing method comprising:
receiving an input including identification information of a specific driver;
specifying, with reference to a storage storing a service period in a specific company and travel data during the service period of the specific driver, the travel data during the service period corresponding to the specific driver; and
acquiring a traveling feature during the service period of the specific driver based on the specified travel data to output the traveling feature.

2. The travel analyzing method according to claim 1, wherein
the receiving includes receiving the input that includes the identification information and the service period of the specific driver, and
the specifying includes specifying travel data that corresponds to the identification information and the service period of the specific driver in the received input.

3. The travel analyzing method according to claim 1, wherein the travel data includes operation information of the specific driver associated with a vehicle travel of the specific driver.

4. The travel analyzing method according to claim 1, wherein the travel data includes biological information of the specific driver associated with a vehicle travel of the specific driver.

5. The travel analyzing method according to claim 1, wherein the traveling feature includes an index that indicates an evaluation extent of safe driving of the specific driver.

6. The travel analyzing method according to claim 1, wherein the traveling feature includes information that indicates a driving type of the specific driver.

7. A travel analyzing apparatus comprising:
a processor configured to:
receive an input including identification information of a specific driver;
specify, with reference to a storage storing a service period in a specific company and travel data during the service period of the specific driver, the travel data during the service period corresponding to the specific driver; and
acquire a traveling feature during the service period of the specific driver based on the specified travel data to output the traveling feature.

8. A non-transitory computer-readable recording medium having stored therein a travel analyzing program that causes a computer to execute a process comprising:
receiving an input including identification information of a specific driver;
specifying, with reference to a storage storing a service period in a specific company and travel data during the service period of the specific driver, the travel data during the service period corresponding to the specific driver; and
acquiring a traveling feature during the service period of the specific driver based on the specified travel data so as to output the traveling feature.
